(19) United States
(12) Patent Application Publication
(10) Pub. No.: US 2008/0222680 A1
(43) Pub. Date: Sep. 11, 2008

(54) Electronic program guide provision apparatus, electronic program guide provision method and program thereof

(76) Inventor: Tomoko Murakami, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/509,014

(22) Filed: Aug. 24, 2006

(30) Foreign Application Priority Data
Aug. 25, 2005 (JP) 2005-244504

(51) Int. Cl. G06F 3/00

(52) U.S. Cl. 725/46

(57) ABSTRACT

An electronic program guide provision system includes a preference model creating unit configured to create a preference model of a viewer in which a causal relationship between a cause of viewing and a viewing effect is written based on an electronic program guide and viewing history information of the viewer, and a recommended program list creating unit configured to create a recommended program list by using the preference model created by the preference model creating unit.

### CROSS-REFERENCE TO RELATED APPLICATION

This application is based upon and claims the benefit of priority from the prior Japanese Patent Application No. 2005-244504, filed Aug. 25, 2005, the entire contents of which are incorporated herein by reference.

### BACKGROUND OF THE INVENTION

1. Field of the Invention

The present invention relates to an electronic program guide provision apparatus, an electronic program guide provision method and a program thereof flexibly considering preferences of viewers concerning program viewing.

2. Description of the Related Art

In recent years, multichannelization of digital broadcasting, e.g., CATV, CS satellite broadcasting or digital terrestrial broadcasting has advanced, and video contents thereby excessively exist. Under such a situation, even an operation of selecting a program in order to watch TV is troublesome. Therefore, a service which selects programs palatable to preferences of a viewer from vast amounts of programs and recommends the selected programs is attracting attention. For example, the following technologies concerning recommendation of programs have been proposed.

(1) Program retrieval based on attributes of programs viewed in the past (see Jpn. Pat. Appln. KOKAI No. 135621-1995 and Jpn. Pat. Appln. KOKAI No. 032797-1998).

Programs are represented by vectors constituted of various attributes characterizing programs, and all programs are mapped in its vector space. Further, an Euclidean distance in the vector space is calculated based on attributes of programs viewed by a viewer in past times to retrieve similar programs, and the retrieved programs are recommended to the viewer. However, this technology does not function successfully unless a viewing history of the viewer is sufficiently stored.

(2) Recommendation of programs to be viewed based on a classification model (see Jpn. Pat. Appln. KOKAI Publication No. 2000-333085 and Jpn. Pat. Appln. KOKAI Publication No. 2001-160955).

Information indicative of whether a viewer has viewed/not viewed in past times is used as a teaching signal, and a model for classifying programs which have been viewed and programs which have not been viewed by the viewer in past times is learned. Furthermore, viewing by the viewer with respect to programs which will be broadcasted in future are predicted based on this model, and the programs which have been predicted to be viewed is recommended to the viewer. However, in this technology, a general tendency of programs which have been viewed/not viewed by a viewer in past times is obtained, but it is difficult to learn an exceptional viewing tendency.

(3) Recommendation of programs based on viewers characteristics (see M. J. Pazzani: A framework for Collaborative, Contents-Baseband Demographic Filtering, Journal of Artificial Intelligence Review, Vol. 13, No. 5-6, pp. 393-408, (1999)).

each group divided based on program characteristics (e.g., a program category) is determined as an objective variable, characteristics of a viewer (e.g., an age, a gender and others) are determined as an explanatory variable, and characteristics of a viewer who has viewed programs belonging to the same group are learned. Programs which will be broadcasted in future is recommended based on the learned model and the characteristics of the viewer. However, with this technology, preferences of each of groups concerning viewing are obtained, but it is difficult to recommend programs adapted to preference of each of viewers.

(4) A programming/recording function based on collaborative filtering (see Jpn. Pat. Appln. KOKAI Publication No. 2003-114903).

A viewer B having a similar viewing tendency to a given viewer A is selected from many viewers based on a past viewing history of the viewer A, and a program to be viewed by the viewer B is also recommended to the viewer A. However, this technology does not function successfully unless both many viewers and a person having similar preferences exist, and it is difficult to cope with new programs whose viewing histories are not stored.

(5) Recommendation of programs based on learning of user behavior patterns (see Jpn. Pat. Appln. KOKAI Publication No. 2004-206445).

Statistical data in which the number of times that a terminal of a contents user has observed a positive operation and a negative operation concerning contents viewing of the contents user is classified in accordance with each day and each time zone is created, thereby learning a user behavior pattern. Moreover, contents which will be desired by the contents viewer for viewing are autonomously retrieved and proposed based on this user behavior pattern. Additionally, the generated user behavior pattern is updated and learned based on Bayes' theorem. However, in this technology, it is required to input user profile information and positive/negative information.

### BRIEF SUMMARY OF THE INVENTION

The present invention enables recommendation of programs which suit preferences of each viewer from a relatively initial stage at which viewing is started, and also enables recommendation of programs flexibly coping with a change in preferences of a viewer.

According to one aspect of the present invention, a Bayesian network type preference model is created in accordance with each viewer from an electronic program guide (EPG) and viewing history information, and a viewing probability value of a viewer with respect to each program is calculated by using the preference model, thereby determining a recommended program based on the viewing probability value of the viewer.

As described above, the preference model of each viewer is created by representing an individual difference by a value (an intensity of a causal relationship) in a conditional probability table of each probability variable in the Bayesian network. Further, a viewing probability value of a viewer with respect to each program is calculated by using the preference model, and recommended programs are determined based on this probability value.

Furthermore, when a value (an intensity of a causal relationship) in the conditional probability table of each probability variable in the Bayesian network is updated from viewing history information of a viewer in a fixed period in past times, the preference model is periodically updated.

### BRIEF DESCRIPTION OF THE SEVERAL VIEWS OF THE DRAWINGS

FIG. 1 is a view showing an outline configuration of an electronic program guide provision apparatus according to an embodiment of the present invention;

FIG. 2 is a flowchart showing a flow of creating a preference model;

FIG. 3 is a view showing an example of the preference model;

FIG. 4 is a view showing an example in which a structure of a Bayesian network in the preference model depicted in FIG. 3 is written in a computer-readable format;

FIG. 5 shows an example of an electronic program guide (EPG) which is a target in the embodiment according to the present invention;

FIG. 6 is a view showing viewing history information of a given viewer with respect to the electronic program guide depicted in FIG. 5;

FIG. 7 shows an example of values in a conditional probability table calculated and output in accordance with the preference model depicted in FIG. 3 in the embodiment according to the present invention;

FIG. 8 is a flowchart showing a recommended program list creating procedure for providing an electronic program guide suiting preferences of a viewer; and

FIG. 9 shows an example of recommended program data created in the embodiment according to the present invention.

### DETAILED DESCRIPTION OF THE INVENTION

An embodiment according to the present invention will now be described with reference to the accompanying drawings. It is to be noted that the following will describe recommendation of television programs while targeting data concerning television programs when providing an electronic program guide, but target data in the present invention is not restricted thereto, and general broadcasting contents can be extensively used as a target. Therefore, an effect of the present invention can be shown not only in recommendation of television programs suiting preferences of each viewer in this embodiment but also extensively in a broadcasting contents information provision apparatus. It is to be noted that a model in which preferences concerning program viewing of each viewer are written will be referred to as a “preference model” in the present invention.

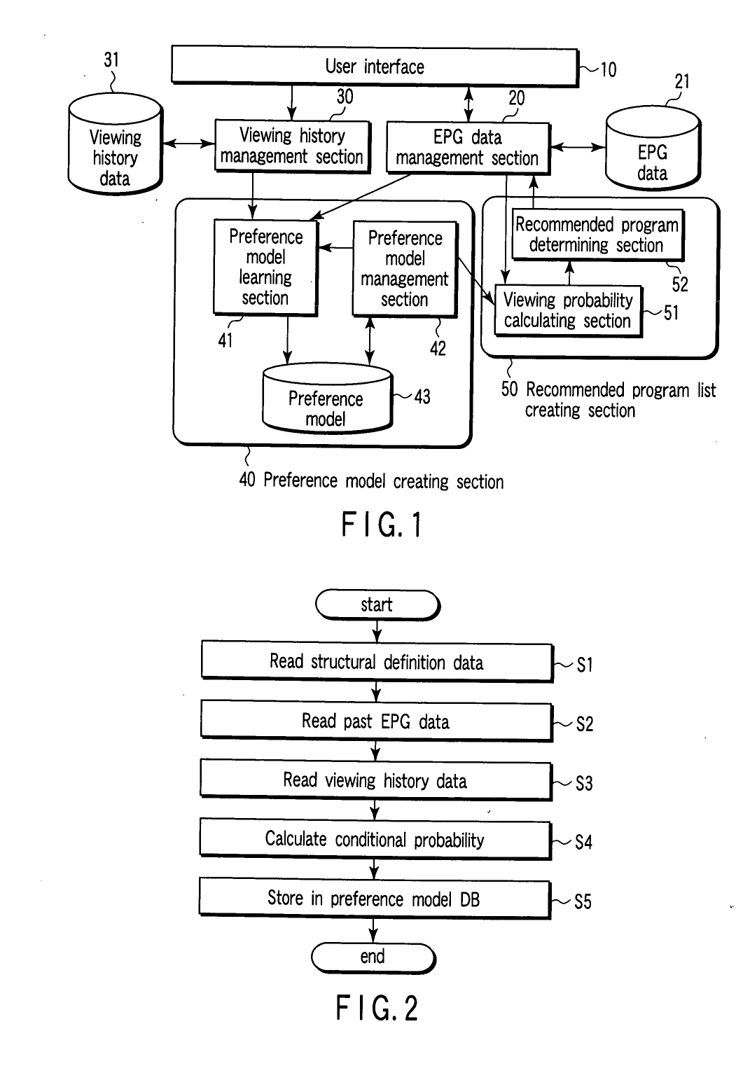

FIG. 1 is a view showing an outline configuration of an electronic program guide provision apparatus according to an embodiment of the present invention.

The electronic program guide provision apparatus depicted in FIG. 1 includes a user interface 10 which communicates with an external device (e.g., a TV set or a display device), an EPG data management section 20 which receives and manages, e.g., television program information (which may be simply referred to as “television program information” hereinafter) which is an electronic program guide (EPG) from the user interface 10, a viewing history information management section 30 which receives, manages and periodically updates viewing history information of a user from the user interface 10, a preference model creating section 40 which creates a preference model based on the electronic program guide and the viewing history information, and a recommended program list creating section 50 which creates a recommended program list from the preference model created in the preference model creating section 40 and the electronic program guide. Furthermore, EPG data input to the EPG data management section 20 is recorded in an EPG database 21, and a viewing history input to the viewing history information management section 30 is recorded in a viewing history database 31.

The preference model creating section 40 has a preference model learning section 41 which receives as input information television program information in a past fixed period and viewing history information of a viewer with respect to the television program information from the EPG data management section 20 and the viewing history information management section 30 in order to create a preference model, a preference model management section 42 which manages structural definition data and conditional probability values which will be described later in detail as the preference model, and a preference model database 43 which records the preference model created by the preference model learning section 41. It is to be noted that the preference model learning section 41 has a function of receiving a new electronic program guide and viewing history and updating the preference model periodically or when the predetermined number of sets of data are input thereto.

The recommended program list creating section 50 has a viewing probability calculating section 51 and a recommended program determining section 52. The viewing probability calculating section 51 receives EPG data from the EPG data management section 20 and the conditional probability values of the preference model from the preference model management section 42, and calculates viewing probabilities of television programs which will be broadcasted in future. The recommended program determining section 52 determines recommended programs based on the viewing probabilities calculated by the viewing probability calculating section 51. Moreover, the recommended programs determined by the recommended program determining section 52 are displayed in, e.g., a non-illustrated TV set or the like through the EPG data management section 20 and the user interface 10.

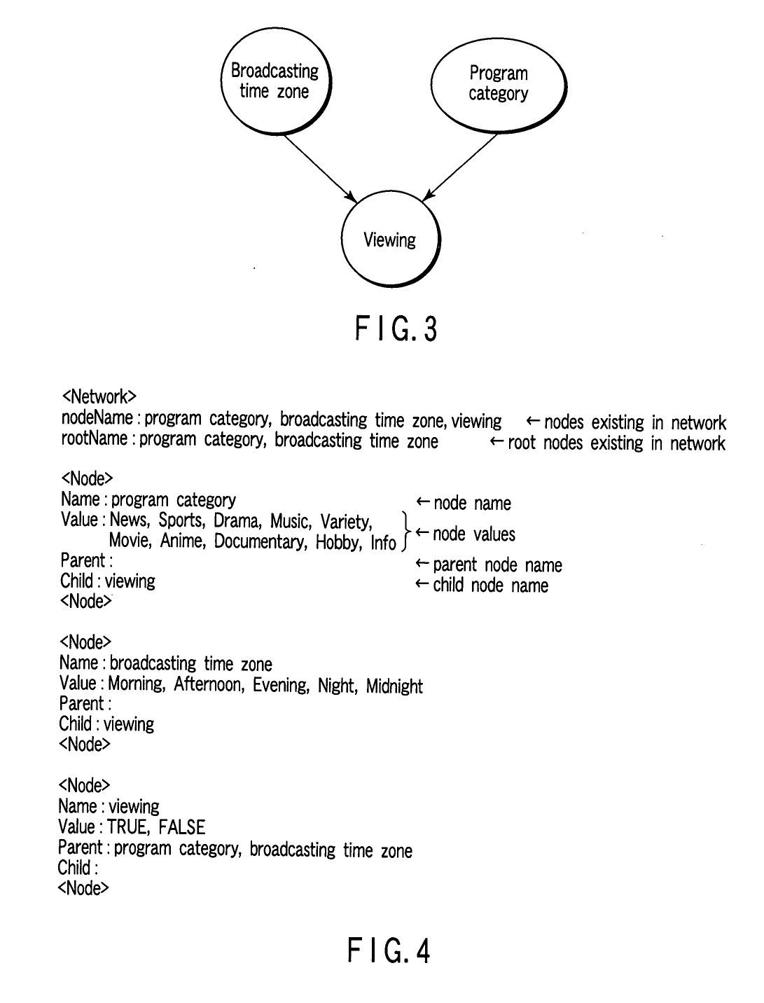

An operation of the thus configured electronic program guide provision apparatus according to an embodiment of the present invention will now be described. First, referring to FIG. 2, a preference model creating procedure will be explained. FIG. 2 is a flowchart showing a flow of creating a preference model. FIG. 3 shows an example of the preference model which is a target of the embodiment according to the present invention. However, the preference model depicted in FIG. 3 is just an example of the preference model, and the present invention is not restricted thereto. The preference model which is a target of this embodiment is a model which is expressed in a bayesian network. The bayesian network is a model represented by a directional acyclic graph in which a link has a direction along a direction of a causal relationship and a path following this link does not circulate in a probability network as a probability model based on a graph structure in which a probability variable is represented by a node and a link is provided between variables having a dependency relationship such as a causal relationship or a correlation. The model shown in FIG. 3 is a preference model in which probability variables are determined as a “broadcasting tie zone” and a “program category” and a causal relationship that the “broadcasting time zone” and the “program category” cause viewing is written.

First, the preference model learning section 41 reads such structural definition data as shown in FIG. 4 in which a structure of the preference model is defined (step S1). In FIG. 4, a structure of a Bayesian network in the preference model depicted in FIG. 3 is written in a computer-readable format. In FIG. 4, three elements, i.e., “broadcasting time zone”, “program category” and “viewing” are defined as probability variables. Additionally, in FIG. 4, values assigned to the respective probability variables are also defined. For example, as values of the “program category”, there are 10 types of values, i.e., “news (News)”, “sports (Sports)”, “drama (Drama)”, “music (Music)”, “variety (Variety)”, “movie (Movie)”, “animation (Anime)”, “documentary (Documentary)”, “hobby (Hobby)” and “information (Info)” Likewise, as values of the “broadcasting time zone”, there are five types of values, i.e., “morning (Morning)”, “afternoon (Afternoon)”, “evening (Evening)”, “night (Night)” and “midnight (Midnight)”. As values of “viewing”, there are two types of values, i.e., “viewing (TRUE)” and “not viewing (FALSE)”. Further, in order to define a causal relationship, a probability variable which can be a cause is determined as a “parent node (Parent)” and a probability variable which can be an effect is determined as a “child node (Child)” so that corresponding probability variables are written.

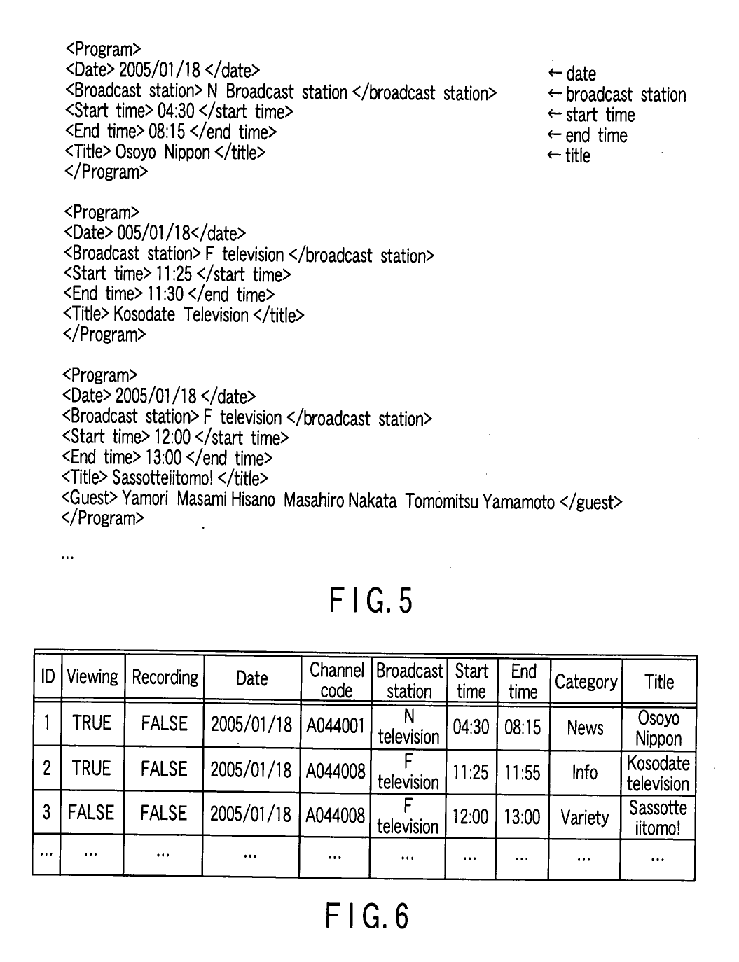

The preference model learning section 41 then reads an electronic program guide in a past fixed period such as shown in FIG. 5 from the EPG data management section 20 (step S2). FIG. 5 shows an example of the electronic program guide (EPG) which is a target in the embodiment according to the present invention. As shown in FIG. 5, the electronic program guide consists of a date, a broadcast station, start and end times and a title in accordance with each program. Guest information is additionally provided as required. In the example shown in FIG. 5, as television programs in Jan. 18, 2005, “Osoyo Nippon” is broadcasted on N television from 4:30 to 11:30, “Kosodate Television” is broadcasted on F television from 11:25 to 11:30, and “Sassotteiitomo!” is broadcasted on F television from 12:00 to 13:00. Further, in “Sassotteiitomo”, Yamori, Masami Hisano, Masahiro Nakata and Tomomitsu Yamamoto appear as guests on the show.

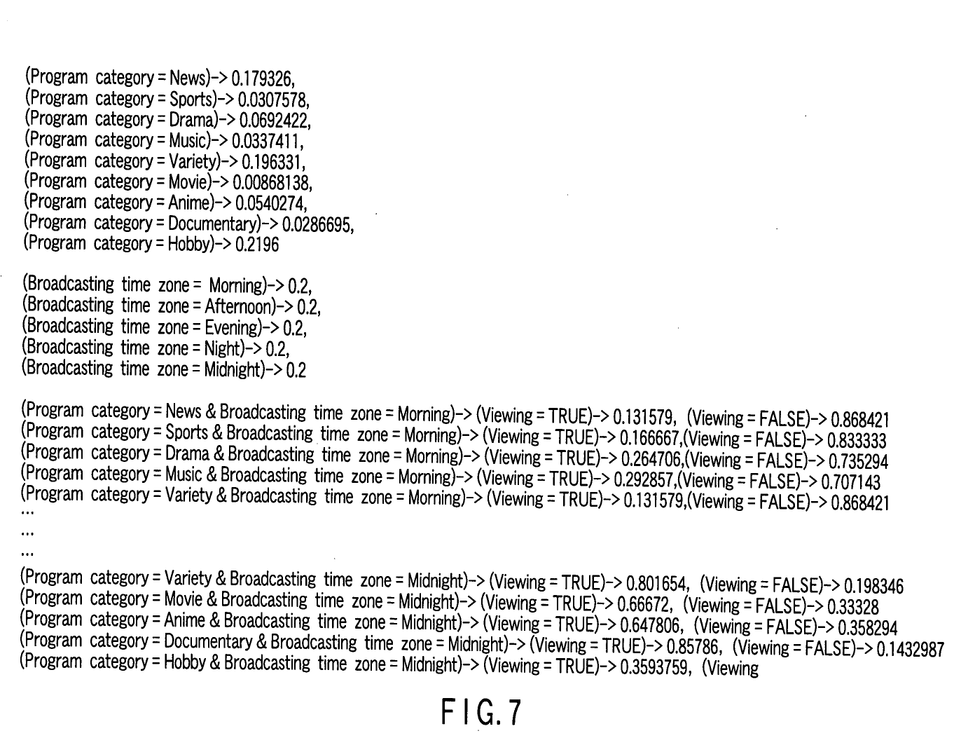

Then, the preference model learning section 41 reads such viewing history information in a past fixed period as shown in FIG. 6 from the viewing history information management section 30 (step S3). FIG. 6 is a view showing an example of the viewing history information of a given viewer with respect to the electronic program guide shown in FIG. 5. FIG. 6 represents the viewing history information of the electronic program guide depicted in FIG. 5 by using values “TRUE” and “FALSE”. Specifically, when an value is “TRUE”, this means that viewing or recording was performed. In case of “FALSE”, this means that viewing or recording was not performed. For example, since programs having “TRUE” as an value of “viewing” are “Kosodate Television” and “Osoyo Nippon” in FIG. 5, this means that the viewer watched these two programs but did not perform recording. In this case, this viewing history information is information concerning a result that a viewer actually watched or did not watched.

The preference model learning section 41 calculates conditional probability values of respective probability variables in the bayesian network (step S4), and stores the obtained result together with the structural definition data as a preference model in the database (step S5). As a calculation method of conditional probability values at the step S4, conditional probability values may be obtained by calculating these values as frequencies of programs meeting conditions from such viewing history information in a past fixed period as shown in FIG. 6, or by setting arbitrary values by a system designer. It is to be noted that the preference model management section 42 manages such structural definition data as shown in FIG. 4 and such conditional probability values as shown in FIG. 7 as a preference model.

FIG. 7 shows an example of values in a conditional probability table calculated and output in the embodiment according to the present invention. It is to be noted that values in the conditional probability table are calculated by using the viewing history of each viewer shown in FIG. 6 in this embodiment, but a system designer or a user may set arbitrary values in advance. In FIG. 7, probability values are defined in a case where the probability variable “program category” takes respective values. For example, a description (program category=News)->0.179326 in a first line means that a value of probability that News is viewed as a program category is 0.179326. This can be obtained by, e.g., calculating a frequency of a program whose “program category” is “News” in all programs included in the viewing history of each viewer shown in FIG. 6. Thereafter, probability values of various program categories, e.g., “Sports” or “Drama” are likewise defined. Furthermore, in regard to the probability variable “broadcasting time zone”, viewing probability values are likewise defined. On the other hand, probability values of “viewing” are affected by the “broadcasting time zone” and the “program category” in accordance with the preference model shown in FIG. 3, and hence probability values are defined under conditions of variations of all respective values of the “broadcasting time zone” and the “program category”. For example, a description (program category=Variety & broadcasting time zone=Midnight)->(viewing=TRUE)->0.801654 in a fifth line from the bottom in FIG. 7 means that a value of probability that a viewer watches a program whose “program category” is “Variety” and whose “broadcasting time zone” is “Midnight” is 0.801654 and a value of probability that the viewer does not watch this program is 0.198346. This can be obtained by, e.g., calculating a frequency of a program in accordance with presence/absence of “viewing” in programs whose “program category” is “Variety” and whose “broadcasting time zone” is “Midnight” included in the viewing history of the viewer shown in FIG. 6.

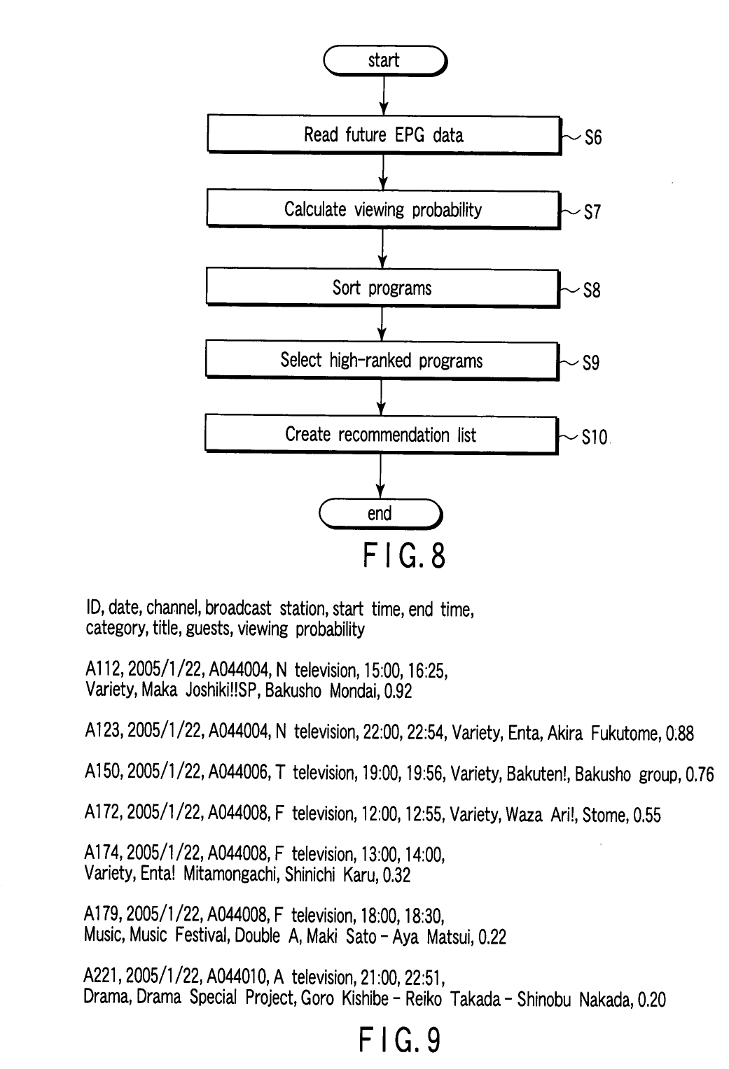

A description will now be given on a procedure of creating a program list for recommendation based on a preference model in which defines probability values shown in FIG. 8. FIG. 8 is a flowchart showing a recommended program list creating procedure for providing an electronic program guide which suits preferences of a viewer.

The viewing probability calculating section 51 reads future EPG data from the EPG data management section 20 (step S6), and calculates viewing probabilities based on this EPG data and conditional probability values in a preference model from the preference model management section 42 (step S7).

The recommended program determining section 52 sorts television programs which will be broadcasted in future based on the viewing probabilities (which are specifically given as probability values) calculated in the viewing probability calculating section 51 (step S8), and selects high-ranked programs as recommended programs (step S9). FIG. 9 shows an example of recommended programs. FIG. 9 shows an example of recommended program data created in the embodiment according to the present invention. In the example depicted in FIG. 9, a program called “Maka Joshiki!! SP” has the highest viewing probability of 0.92, and is listed as a recommended program.

Moreover, the recommended program data is stored as a recommendation list in the EPG data management section 20 (step S10). Here, as methods of selecting high-ranked programs, there are various methods, e.g., a method of selecting the predetermined number of high-ranked programs, a method of setting a threshold value concerning the viewing probability and selecting programs each having a value equal to or above this threshold value, and others. However, any methods can be adopted. The user interface 10 receives the recommended program data determined by the recommended program determining section 52 from the EPG data management section 20, and presents it as recommended program information to a user.

In the embodiment according to the present invention, the electronic program guide shown in FIG. 5 which is received from, e.g., an external broadcasting device or the viewing history of each viewer shown in FIG. 6 which is obtained by, e.g., monitoring a television operation by the viewer is determined as system input information in, e.g., the user interface 10 depicted in FIG. 1. It is determined that the electronic program guide or the viewing history information of each viewer is information having not only contents shown in FIG. 5 but also various formats or definitions, and such information is input through keyboard input, remote controller input, online input based on a network, reading from a magnetic tape as a communication medium and others.

For example, the preference model is updated in the preference model learning section 41 in the foregoing embodiment but, e.g., a preference model updating section may be additionally provided in order to update a preference updating model.

Although updating of the preference model has not been described in detail in the foregoing embodiment, but the preference model may be updated in the following manner. First, the preference model management section 42 calls the preference model learning section 41 in order to periodically update the preference model, and calls the viewing probability calculating section 51 in order to update the recommended program list. The preference model and the recommended program list are updated by executing all the steps in creating the preference model shown in FIG. 2 and all the steps in creating the recommended program list depicted in FIG. 8. It is to be noted that a frequency of updating may be once a day or once a week.

According to the present invention, it is possible to recommend programs which adapt to preference of each viewer from a relatively initial stage at which viewing is started, and recommend programs which can flexibly cope with a change in preferences of a viewer.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An electronic program guide provision system comprising:
a preference model creating unit configured to create a preference model of a viewer in which causal relationships between viewing and its causes is written based on an electronic program guide and viewing history information of the viewer; and
a recommended program list creating unit configured to create a recommended program list by using the preference model created by the preference model creating section.

2. The electronic program guide provision system according to claim 1, wherein causes of viewing includes a broadcasting time zone and a program category.

3. The electronic program guide provision system according to claim 1, wherein, a bayesian network determined by introducing probability variables and conditional probabilities defined as causal relationships is defined as a preference model in which preferences of the viewer concerning program viewing are described.

4. The electronic program guide provision system according to claim 3, wherein the preference model creating unit comprises: a preference model learning unit configured to create a bayesian network type preference model in accordance with each viewer; and a preference model management unit configured to configure a preference model of a viewer by representing differences among individuals by values in a conditional probability table of the respective probability variables in the bayesian network.

5. The electronic program guide provision system according to claim 1, wherein the program list creating unit comprises: a viewing probability calculating unit configured to calculate a viewing probability value of the viewer with respect to each program by using the preference model created by the preference list creating unit; and a recommended program determining unit configured to determine a recommended program based on the viewing probability value of the viewer.

6. The electronic program guide provision system according to claim 5, wherein the recommended program determining unit sorts programs based on the viewing probability values of the viewer calculated by using the preference model created by the preference model creating unit, and recommends high-ranked programs.

7. The electronic program guide provision system according to claim 1, wherein the preference model creating unit further comprises a preference model updating unit configured to periodically update the preference model.

8. The electronic program guide provision system according to claim 7, wherein the preference model updating unit updates values in the conditional probability table of the respective probability variables in a bayesian network from viewing history information of the viewer in a past fixed period after a time point of updating.

9. An electronic program guide provision method which provides an electronic program guide suiting program preferences of a viewer, comprising:
creating a preference model of the viewer in which causal relationships between viewing and its causes are written based on the electronic program guide and viewing history information of the viewer; and
creating a recommended program list by using the created preference model.

10. A computer-readable program which provides an electronic program guide suiting program preferences of a viewer, comprising:
creating a preference model of the viewer in which casual relationships between viewing and its causes are written based on the electronic program guide and viewing history information of by the viewer; and
creating a recommended program list by using the preference model created by a preference model creating unit.
